(19) United States
(12) Patent Application Publication
(10) Pub. No.: US 2015/0161334 A1
(43) Pub. Date: Jun. 11, 2015

(54) DISTRIBUTION OF MEDICAL REPORT

(71) Applicant: WILLIAM M. BOUSHKA, EL PASO, TX (US)

(72) Inventor: WILLIAM M. BOUSHKA, EL PASO, TX (US)

(73) Assignee: WILLIAM M. BOUSHKA, EL PASO, TX (US)

(21) Appl. No.: 14/567,417

(22) Filed: Dec. 11, 2014

Related U.S. Application Data
(60) Provisional application No. 61/914,816, filed on Dec. 11, 2013.

(51) Int. Cl. G06F 19/00; H04L 29/08

(52) U.S. Cl. CPC G06F 19/322; H04L 67/06; H04L 67/12

(57) ABSTRACT

An approach for distribution of medical records and reports between medial offices with a distribution server that makes the medical records available to one or more requesting servers.

### RELATED APPLICATIONS

This application claims priority to U.S. Provisional Application No. 61/914,816, titled DISTRIBUTION OF MEDICAL REPORT, filed on Dec. 11, 2013, which is incorporated by reference herein.

### FIELD OF THE INVENTION

This application relates generally to the distribution of records, and more particularly, to electronic distribution of medical records.

### BACKGROUND

Currently, medical facilities are under pressure from government regulation to switch from paper patient charts to Electronic Medical Records (EMRs). If a radiology clinic, lab, or other medical facility wishes to transfer data from their EMR to another EMR, expensive electronic interfaces are used which require payments to both the sending and receiving EMRs. Additionally, the fees to set up and maintain these communication links can amount to tens of thousands of dollars. Consequently, these cost associated with electronic transfers usually prevent medical facilities from adopting such systems. Thus, medical records and reports are usually faxed from one EMR to another using a manual process. Each fax must be manually filed in the EMR after it is scanned into the system.

In view of the foregoing, there is an ongoing need for systems, apparatuses, and methods for automatically sending and filing medical records and report electronically.

### SUMMARY

In view of the above, an approach is provided for securely transferring medical records from a distribution server that resides in a first medial office to a server that resides in a second medical office. The distribution server stores the medical records or reports in a folder and the client in the second medical office periodically checks if medical records or reports are in that folder on the distribution server. If medical records or reports are present, then the client located at the second medial office initiates a download of the medical records or reports and then transfers it to the EMR server in the second office.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 shows an exemplary electronic medical records (EMRs) distribution approach in accordance with an example implementation of the invention;

FIG. 2 shows a block diagram of a distribution server of FIG. 1 located at a radiological clinic;

FIG. 3 illustrates a messaging diagram between the first doctor's EMR, the distribution server and the server at the second medical office FIG. 1; and

FIG. 4 illustrates a flow diagram of the approach for the distribution of EMRs in accordance with an example implementation of the invention.

### DESCRIPTION

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived there from.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

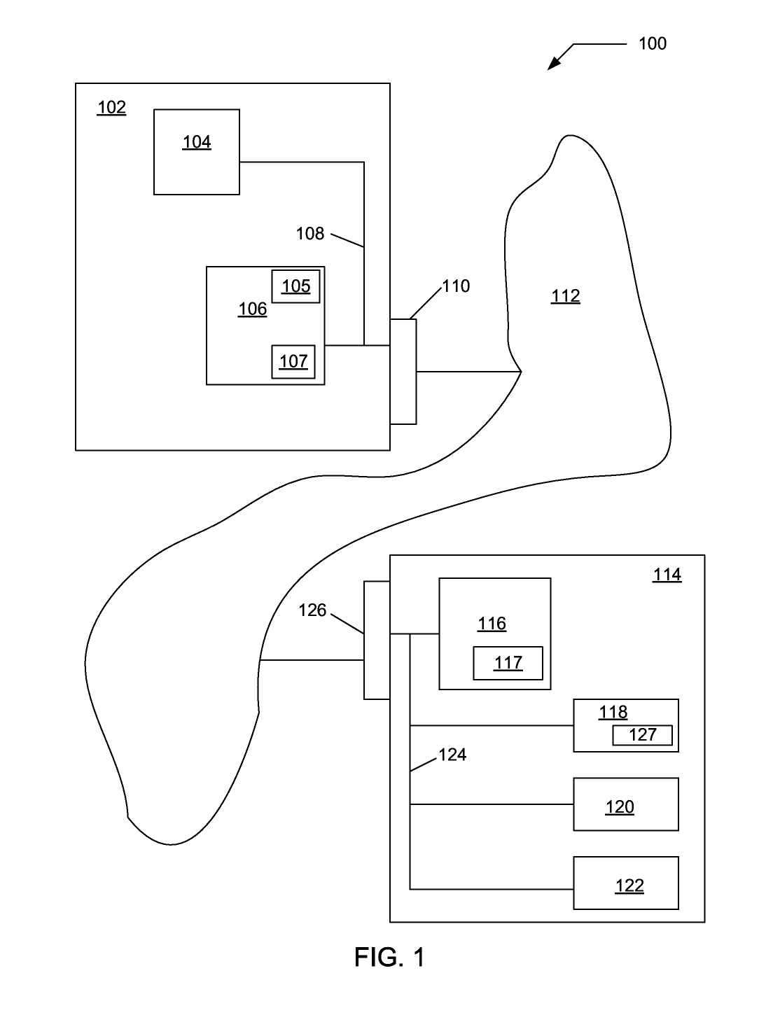

In FIG. 1, an illustration 100 of an exemplary electronic medical records (EMRs) distribution approach in accordance with an example implementation of the invention is shown. A first medical office, (radiology clinic) 102 having a data server for the clinic's EMR 104 that is in electronic communication with a distribution server 106 via a network 108. The distribution server 106 may have an outbox or folder 107 for each medical office to which medical records may be transferred. TA firewall enabled device 110 may separate the network 108 from a network commonly called the internet 112. A second medical office (clinic) 114, has its own EMR server 116. The server 116 may have a general inbox or folder 117 for receipt of medical records or reports from outside sources. The server 116 may be in communication with one or more of its clients, installed on personal computers 118, 120, 122 via network 124. The distribution client 127 periodically checks if records are ready in the First Medical Office to be transferred to the second medical office. In other implementations, the clients may be any type of networkable device, including pads, smart cellular telephones, and laptop computers. The network 124 may be coupled to the internet 112 via firewall enabled device 126. The networks 108 and 124 may be implemented as a wired network, wireless network, or a combination of wired and wireless networks.

In other implementations, a general mail box 105 may be implemented that is scanned in order to identify tags, identifiers, or email addresses of medical offices to which the EMR may transfer records. Similarly, a general mail box may be employed at server 116 to receive the medical records, where the received medical records are scanned to identify where to file or send the received medical record or file.

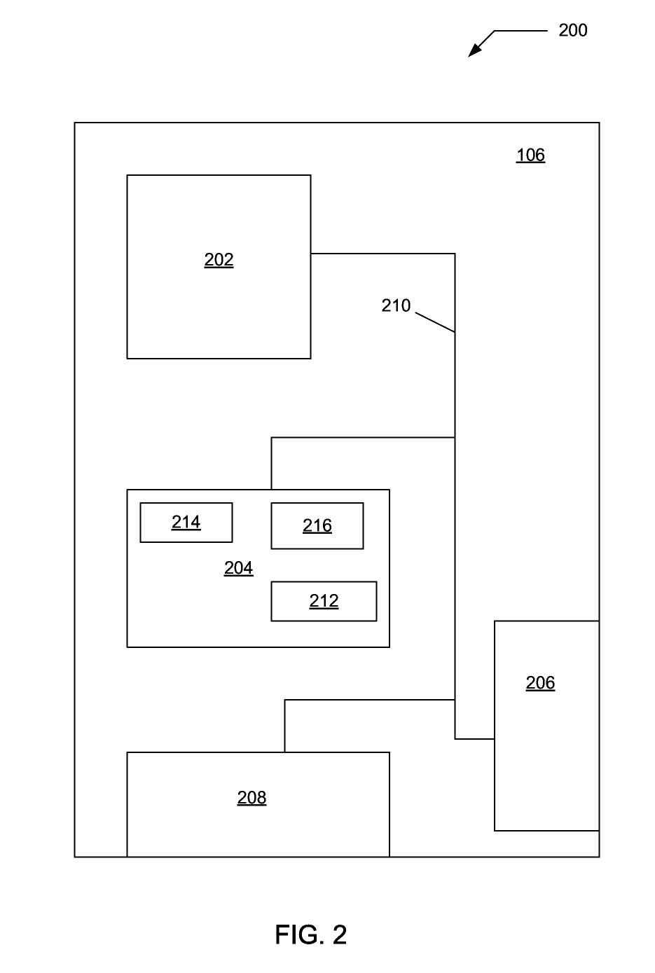

Turning to FIG. 2, a block diagram 200 of a distribution server 106 of FIG. 1 located at a radiological clinic 102 is shown. The distribution server 106 has a controller 202 coupled to a memory 204, network interface 206, and I/O interface 208 by one or more buses (typically electrical data and address buses). In practice, the controller 202 may be implemented as one or more controllers with one or more cores. Examples of controllers include microprocessors, arm processors, RISC processors, digital signal processors, digital circuits functioning as a state machine, analog circuits functioning as a state machine, or a combination of analog and digital circuits functioning as a state machine. The memory 204 may be random access memory (RAM), read only memory ROM, or a combination of RAM and ROM. The memory 204 may be divided into different areas including a program memory area 212 that stores machine readable instructions, commonly referred to as software and operating system memory 214. The network interface 206 may be an Ethernet interface, wireless interface (such as an 802.3n interface or cellular 4G interface). The I/O interface 208 is an interface that allows the server to connected to peripheral devices, such as a keyboard, mouse, video monitor via one or more ports (such as VGA, HDMI, USB, Serial, and Parallel ports).

The memory 204 of the distribution server 106 may have a database 212 for storing medical reports and records along with associated data, such as where and when records have been sent, requests to send records, and who has accessed the record. Individual folders associated with where records and reports are to be sent may also be created in memory 216 and/or files on a hard disk. Examples of a database that may be employed include SQL, data structures such as link list, has tables, or similar structures, and even a flat file. In other implementations, the distribution server 106 may be implemented as hardware, software, or as in the current example, a combination of hardware and software.

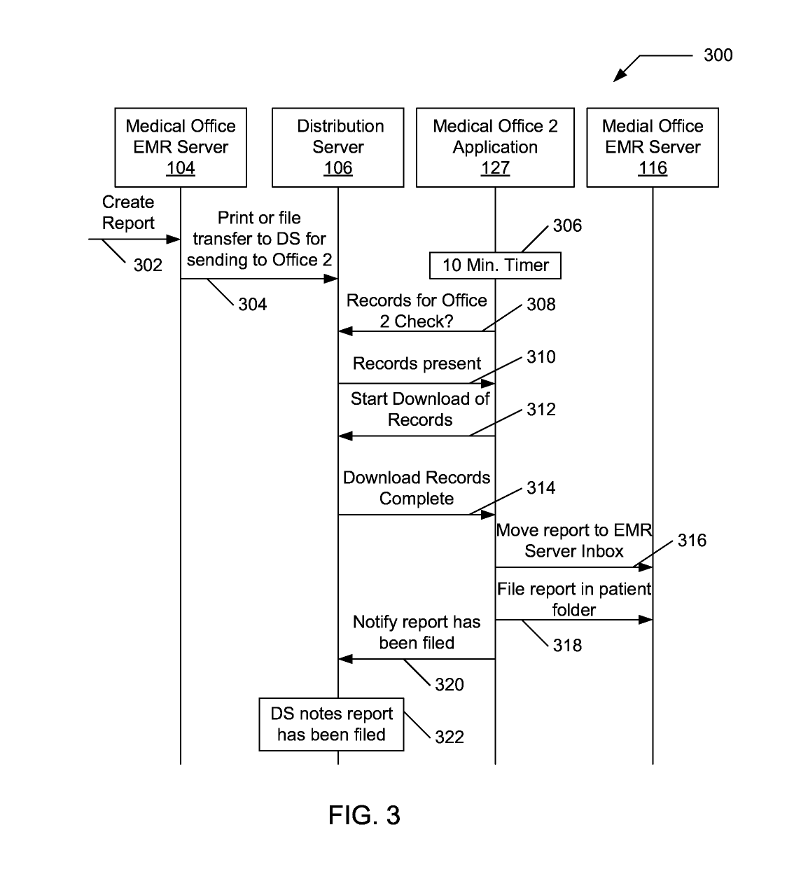

In FIG. 3, a messaging diagram 300 between the EMR server 104 at the first office, the distribution server 106 at first medical office 102 and the server 116 at the second medical office 114. The medical report or record is entered into the EMR system that may reside on server 104 in the first medical office 102. The medical report or record may be entered into or created by the EMR system (302). One approach for creation of a medical record or file may be by printing the medical record or file to a print driver specially configured to print the report into the distribution server 106 (as a file in the current implementation). When that medical record needs to be sent to another medical office, such as the second medical office 114, it may be printed from the EMR system to the distribution server (304) via a printer driver configured to print to the distribution server's general mailbox, folder 105. Other methods of file transfer are also anticpated. The distribtion server will read the report and extract the demographic data from the report and determine to which medical office the report should be distributed. In this example, this corresponds to folder 107, FIG. 1 associated with the second medical office 114. The file containing the report will be placed in the proper folder for distribution and will be renamed using the demographic data of the report (patient name, date of birth, exam type, exam date and so forth). The renaming of the file is to assist in ease in identifing the report for later filing. Alternatively, meta-data may be added to the report file for the same purpose. The distribution client application 127 located on computer 118 located in the second medial office 114 may periodically (308), such as with a timer that expires every 10 minutes (306), check if records are contained in the folder 107. In other implementations, the distribution server 106 may send an indication to the second medical office client 127, indicating that a medical record is ready for transmission.

If a medical record is ready for transmission in the folder 107 on the distribution server (310), then the application 127 in the second medical office starts a secure download of the medical record (312) and the medical record or report is downloaded from the distribution server 106 (314). Once downloaded, the medical record or report is then filed in the EMR system of the second medical office using information associated with the medial record or report or placed in a EMR server 116 inbox 117 (316). In the current example, the information may be contained in the name of the file. In other implementations, the information may be contained in a text file downloaded with the record or meta-data associated with the downloaded files.

The method for filing the report in the second doctors office's EMR 116 will now be discussed. EMR's may have a graphical user interfaces that allow users to file reports (PDF or other file formats) in the proper patient folder in the EMR. This typically may be done manually using the graphical user iterface from the EMR software. In the current approach, the distribution client 127 may be directed via software to logon to the second doctor's office EMR, and use its graphical user interface to file the downloaded reports automatically. Another implementation may incorporate meta-data markers containing the demographic data for the medical report in the medical report file and place the report in the general inbox of the second EMR. If the report cannot be filed with automation, it may filed manually in the second EMR by the personnel in the second doctor's office, or be printed by the distribution client as a hardcopy to a printer in the second doctor's office.

The downloaded records may then be filed and an alert or message sent to the technician or Doctor who need to review the medical report or file. One approach from filing the medical reports or files is to have a program scan the director of the download material and reading tags, file naming convention, or other identification information, file the medial report or file and send the notification (318). In other approaches, an individual may be assigned to verify receipt of the report and review it prior to filing and sending a notification. The notification that may be sent may indicate that the medial record or report has been downloaded and/or entered into the EMR system at the second medial office 118. The notification may be in the form of an email that is sent to a mail client that is being executed on a network client device such as 118.

A notification may also be sent to the distribution server 106 that the medical record or file has been downloaded and filed at the second medical office (320) The distribution server 106 may then indicate in a database or on the record that the file has successfully been transferred (322).

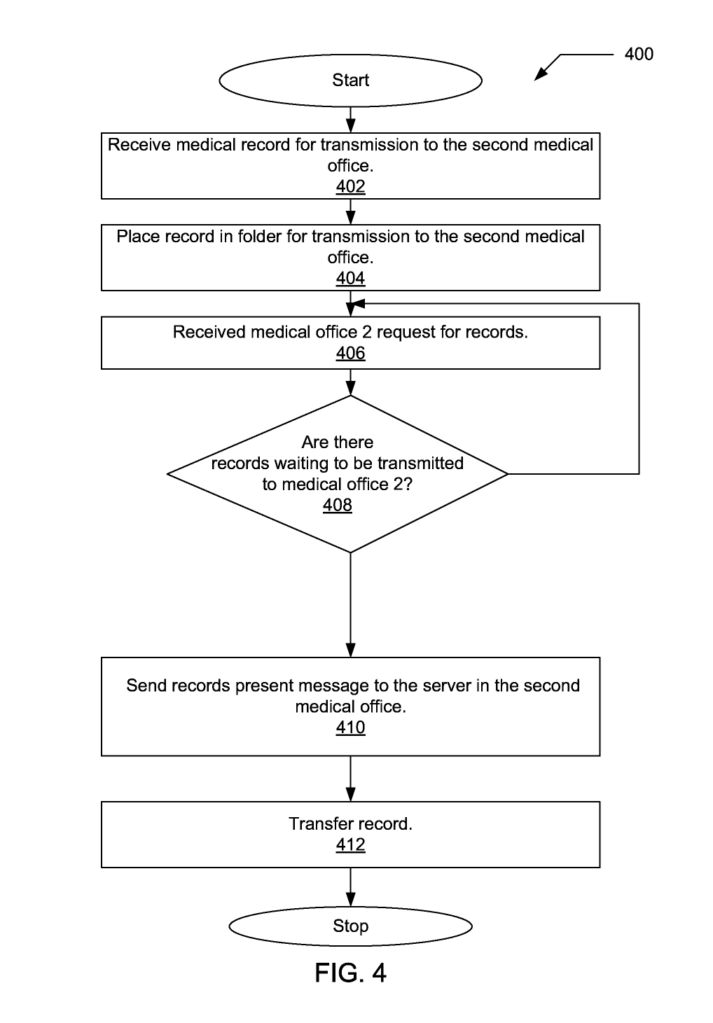

Turning to FIG. 4, a flow diagram 400 of the approach for the distribution of EMRs in accordance with an example implementation of the invention is illustrated. The approach starts with the distribution server 106 receiving a medical record of report for transmission to the second medical office 114 in step 402. The received medical record or report is stored in a folder 107 for transmission to the second medical office in step 404. The only documents to be placed in folder 107 are documents that need to be transported to second medical office. In other implementations, the medical records may have some other grouping or identification that indicates that they need to be transmitted to a predetermined other medical office. Periodically, the distribution client 127 in the second medical office 114 sends a message to the distribution server 106 asking if medical records or reports need to be transmitted to the second medical office 116 in step 406.

If there are records waiting to be transmitted to the second medical office 408, then the distribution server 106 responds with a message to the distribution client 127 in the second medical office 114 indicating records or reports are waiting to be transferred in step 410. If no records are present, then no action is taken and a timeout occurs on the distribution client 127 because no response was received and the distribution client 127 waits for a query from the distribution server 106 at step 406. Otherwise the records are transferred to the second medical office 114 in step 412. In the current implementation, the transfer may occur using a FTPS transfer protocol. But in other implementations, other types of file transfers may be employed. In yet other implementations, additional encryption of the medical records or reports may occur.

It will be understood and appreciated that one or more of the processes, sub-processes, and process steps described in connection with FIG. 4 may be performed by hardware, software, or a combination of hardware and software on one or more electronic or digitally-controlled devices. The software may reside in an application memory in a suitable electronic processing component or system such as, for example, one or more of the functional systems, devices, components, modules, or sub-modules schematically depicted in FIG. 2. The application memory may include an ordered listing of executable instructions for implementing logical functions (that is, “logic” that may be implemented in digital form such as digital circuitry or source code or in analog form such as an analog source such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored there in which, when executed by a processing module of an electronic system, direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read-only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

What is claimed is:

1. An electronic medical record distribution apparatus, comprising:
a processor coupled to a memory;
an input able to receive an electronic medical record, where the input device is coupled to the processor;
at least one mailbox in memory accessible by the processor that receives the electronic medical record from the input, where the electronic medical record is identified as needing to be transferred to a predetermined medical office; and
a network interface that is able to transmit the electronic medical record in response to an indication that the electronic medical record is to start transmission to a second server at the predetermined medical office.

2. The electronic medical record distribution apparatus of claim 1, where the indication that the electronic medical record may be transmitted, includes an indication sent via the network interface to the second server at the predetermined medical office that the electronic medical record is ready for transfer.

3. The electronic medical record distribution apparatus of claim 1, where the transmission is a file transfer protocol (FTPS) transfer of the electronic medical record.

4. The electronic medical record distribution apparatus of claim 1, where the transmission is an encrypted transmission of the electronic medical record.

5. The electronic medical record distribution apparatus of claim 1, where the electronic medical record is encrypted by the processor when placed in the at least one mailbox.

6. The electronic medical record distribution apparatus of claim 1, where the electronic medical record has a file name that identifies the predetermined medical office, patient, and an associated exam.

7. The electronic medical record distribution apparatus of claim 1, where the electronic medical record has a tag that identifies the predetermined medical office.

8. The electronic medical record distribution apparatus of claim 1, where the electronic medical record has metadata that identifies the predetermined medical office.

9. An electronic medical record distribution system, comprising:
a first processor coupled to a first memory at a first server;
an input able to receive an electronic medical record, where the input device is coupled to the first processor;
at least one mailbox in the first memory accessible by the first processor that receives the electronic medical record from the input, where the electronic medical record is identified as needing to be transferred to a second server; and
a first network interface that is able to transmit the electronic medical record in response to an indication received from the second server that is an indication to start transmission of the medical record to the second server.

10. The electronic medical record distribution system of claim 10, where the indication is in response to a record present notification sent via the first network interface to the second server at the predetermined medical office.

11. The electronic medical record distribution system of claim 10, where the transmission is a file transfer protocol (FTP) transfer of the electronic medical record between the first network interface and the second network interface.

12. The electronic medical record distribution system of claim 10, where the transmission is an encrypted transmission of the electronic medical record between the first network interface and the second network interface.

13. The electronic medical record distribution system of claim 10, where the electronic medical record is encrypted by the first processor when placed in the at least one mailbox.

14. The electronic medical record distribution system of claim 10, where the electronic medical record has a file name that identifies the predetermined medical office, patient, and the associated exam.

15. The electronic medical record distribution system of claim 10, where the electronic medical record has metadata that identifies the predetermined medical office, patient, and the associated exam.

16. An electronic medical record distribution method, comprising:
receiving an electronic medical record at an input coupled to a processor;
placing the electronic medical record in an at least one mailbox in a memory accessible by the processor, where the electronic medical record is identified as needing to be transferred to a predetermined medical office; and
transmitting via a network interface the electronic medical record in response to an indication that the electronic medical record is to start transmission to a second server at the predetermined medical office.

17. The electronic medical record distribution method of claim 17, where the indication that the electronic medical record may be transmitted, includes sending an indication via the network interface to the second server at the predetermined medical office that the electronic medical record is ready for transfer.

18. The electronic medical record distribution method of claim 17, further includes receiving a start download indication at the network interface; and
sending the electronic medical record in response to the start download indication.

19. The electronic medical record distribution system of claim 17, where the transmission is a file transfer protocol (FTP) transfer of the electronic medical record.

20. The electronic medical record distribution system of claim 17, includes encrypting the transmission of the electronic medical record.

21. The electronic medical record distribution system of claim 17, includes encrypting the electronic medical record by the processor when placed in the at least one mailbox.

22. The electronic medical record distribution system of claim 17, where the electronic medical record has a file name that identifies the predetermined medical office.

23. The electronic medical record distribution system of claim 17, where the electronic medical record has metadata that identifies the predetermined medical office.

24. The electronic medical record distribution system of claim 17, where the electronic medical record has a tag that identifies the predetermined medical office.

25. The electronic medical record distribution system of claim 17, further includes accessing a distribution client at the predetermined medical office, where the predetermined medical office has an EMR server and using that EMR server's graphical user interface, the electronic medical record is stored under a proper patient identifier.
